(19) United States
(12) Patent Application Publication
(10) Pub. No.: US 2024/0185465 A1
(43) Pub. Date: Jun. 6, 2024

(54) METHODS, SYSTEMS, AND MEDIA FOR DETERMINING VIEWABILITY OF A CONTENT ITEM IN A VIRTUAL ENVIRONMENT HAVING PARTICLES

(71) Applicant: Integral Ad Science, Inc., New York, NY (US)

(72) Inventors: Adarsh Singh, Pune (IN); Abhishek Vyas, Jalgaon (IN); Tanishq Nimale, Pune (IN); Prashant Jawale, Pune (IN); Vinay Gaykar, Pune (IN)

(21) Appl. No.: 18/530,987

(22) Filed: Dec. 6, 2023

Related U.S. Application Data
(60) Provisional application No. 63/430,632, filed on Dec. 6, 2022.

(51) Int. Cl. G06T 7/90; G06T 7/00

(52) U.S. Cl. CPC G06T 7/90; G06T 7/0002; G06T 2207/10024; G06T 2207/30168

(57) ABSTRACT

Methods, systems, and media for determining viewability of a content item in a virtual environment having particles are provided. In some embodiments, the method comprises: selecting a first plurality of pixels of the content item; determining a first plurality of color values of the first plurality of pixels of the content item; selecting a second plurality of pixels of an image of a rendered screen of a virtual environment; determining a second plurality of color values of the second plurality of pixels of the image of the rendered screen of the virtual environment; comparing the first plurality of color values with the second plurality of color values; and determining whether the content item being presented within the virtual environment is being obstructed by a visual element based on the comparison.

### CROSS-REFERENCE TO RELATED APPLICATION

This application claims the benefit of U.S. Patent Application No. 63/430,632, filed Dec. 6, 2022, which is hereby incorporated by reference herein in its entirety.

### TECHNICAL FIELD

The disclosed subject matter relates to methods, systems, and media for determining viewability of a content item in a virtual environment having particles.

### BACKGROUND

Many people use virtual environments for video gaming, social networking, work activities, and increasingly more activities. Such virtual environments can be highly dynamic, and can have robust graphics processing capabilities that produce realistic lighting, shading, and particle systems, such as snow, leaves, smoke, etc. While these effects can provide a rich user experience, they can also affect digital advertising content that has been placed in the virtual environment. It can be difficult for advertisers to track viewability for their advertisements due to the many variables present in the virtual environment.

Additionally, within some virtual environments, user-generated content can be added dynamically to the virtual environment. Thus, a digital advertisement can be viewable for one particular user but partially or fully obscured for another particular user when new content is added to the virtual environment, thereby increasing the complexity of tracking advertisement views in a virtual environment.

Accordingly, it is desirable to provide new mechanisms for determining viewability of a content item in a virtual environment having particles.

### SUMMARY

Methods, systems, and media for determining viewability of a content item in a virtual environment having particles are provided.

In accordance with some embodiments of the disclosed subject matter, a method for determining viewability of content items in virtual environments is provided, the method comprising: selecting a first plurality of pixels of the content item; determining a first plurality of color values of the first plurality of pixels of the content item; selecting a second plurality of pixels of an image of a rendered screen of a virtual environment; determining a second plurality of color values of the second plurality of pixels of the image of the rendered screen of the virtual environment; comparing the first plurality of color values with the second plurality of color values; and determining whether the content item being presented within the virtual environment is being obstructed by a visual element based on the comparison.

In some embodiments, the first plurality of color values and the second plurality of color values are red, green, and blue (RGB) color values.

In some embodiments, the first plurality of color values and the second plurality of color values are cyan, yellow, magenta, and black (CMYK) color values.

In some embodiments, selecting the first plurality of pixels of the content item further comprises selecting a first reference pixel of the content item and selecting pixels that are proximate to the reference pixel. In some embodiments, selecting the first plurality of pixels of the content item further comprises comparing color values of the reference pixel with color values of the pixels that are proximate to the reference pixel. In some embodiments, selecting the first plurality of pixels of the content item further comprises determining whether to include the first reference pixel in the first plurality of pixels based on the comparison between the color values of the reference pixel with the color values of the pixels that are proximate to the reference pixel.

In some embodiments, the method further comprises selecting a third plurality of pixels of a second image of a second rendered screen of the virtual environment. In some embodiments, the method further comprises: determining a third plurality of color values of the third plurality of pixels of the second image of the second rendered screen of the virtual environment; comparing the first plurality of color values with the third plurality of color values; and determining that the content item being presented within the virtual environment is being obstructed by the visual element based on the comparison.

In some embodiments, the method further comprises determining that the content item is within a view frustum of the virtual environment before selecting the second plurality of pixels of the image of the rendered screen.

In some embodiments, comparing the first plurality of color values with the second plurality of color values comprises determining that the first plurality of color values and the second plurality of color values are approximately the same.

In accordance with some embodiments of the disclosed subject matter, a system for determining viewability of content items in virtual environments is provided, the system comprising a hardware processor that is configured to: select a first plurality of pixels of the content item; determine a first plurality of color values of the first plurality of pixels of the content item; select a second plurality of pixels of an image of a rendered screen of a virtual environment; determine a second plurality of color values of the second plurality of pixels of the image of the rendered screen of the virtual environment; compare the first plurality of color values with the second plurality of color values; and determine whether the content item being presented within the virtual environment is being obstructed by a visual element based on the comparison.

In accordance with some embodiments of the disclosed subject matter, a computer-readable medium containing computer executable instructions that, when executed by a processor, cause the processor to perform a method for determining viewability of content items in virtual environments is provided, the method comprising: selecting a first plurality of pixels of the content item; determining a first plurality of color values of the first plurality of pixels of the content item; selecting a second plurality of pixels of an image of a rendered screen of a virtual environment; determining a second plurality of color values of the second plurality of pixels of the image of the rendered screen of the virtual environment; comparing the first plurality of color values with the second plurality of color values; and determining whether the content item being presented within the virtual environment is being obstructed by a visual element based on the comparison.

In accordance with some embodiments of the disclosed subject matter, a system for determining viewability of content items in virtual environments is provided, the system comprising: means for selecting a first plurality of pixels of the content item; means for determining a first plurality of color values of the first plurality of pixels of the content item; means for selecting a second plurality of pixels of an image of a rendered screen of a virtual environment; means for determining a second plurality of color values of the second plurality of pixels of the image of the rendered screen of the virtual environment; means for comparing the first plurality of color values with the second plurality of color values; and means for determining whether the content item being presented within the virtual environment is being obstructed by a visual element based on the comparison.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an example flow diagram of a process for determining viewability of a content item in a virtual environment having particles in accordance with some embodiments of the disclosed subject matter.

FIG. 2A is an example illustration of a first content item that is determined to be within a view frustum of a virtual environment in accordance with some embodiments of the disclosed subject matter.

FIG. 2B is an example illustration of a second content item that is determined to not be within a view frustum of a virtual environment in accordance with some embodiments of the disclosed subject matter.

FIG. 2C is an example illustration of a content item that is determined to be within a viewport of a virtual environment in accordance with some embodiments of the disclosed subject matter.

FIG. 3 is an example illustration for selecting a first plurality of pixels of a content item in accordance with some embodiments of the disclosed subject matter.

FIG. 4 is an example illustration for selecting one or more pixels within a region of pixels of a content item in accordance with some embodiments of the disclosed subject matter.

FIG. 5 is an example illustration for comparing a second plurality of pixels of a first image of a rendered screen of a virtual environment with a first plurality of pixels of the content item in accordance with some embodiments of the disclosed subject matter.

FIG. 6 is an example illustration for comparing a second plurality of pixels of a second image of a second rendered screen of a virtual environment with a first plurality of pixels of the content item in accordance with some embodiments of the disclosed subject matter.

FIG. 7 is an example block diagram of a system that can be used to implement mechanisms described herein in accordance with some implementations of the disclosed subject matter.

FIG. 8 is an example block diagram of hardware that can be used in a server and/or a user device of FIG. 7 in accordance with some implementations of the disclosed subject matter.

### DETAILED DESCRIPTION

In accordance with various embodiments of the disclosed subject matter, mechanisms (which can include methods, systems, and media) for determining viewability of a content item in a virtual environment having particles. More particularly, the mechanisms can determine whether a content item being presented within a virtual environment is being obstructed by a visual element in a rendered screen of the virtual environment.

In some embodiments, the content item can be an advertising content item. In some embodiments, the content item can include a media content item such as an image, a video, a frame of a video, a sequence of frames of a video, etc., or any suitable combination thereof. In some embodiments, the content item can include text, graphics, logos, etc. that can be used to advertise a particular company, a brand, a product, a service, etc. In some embodiments, the content item can be positioned within the virtual environment. In some embodiments, the content item can be included in, or attached to a surface of any other object within the virtual environment, such as a content item object. In some embodiments, the content item can be stored in any suitable memory and/or storage and in any suitable media file format, such as an image file format, video file format, etc. The content item can be stored in any suitable device, such as a user device, a server, or any suitable combination thereof.

In some embodiments, the virtual environment can be any virtual environment that can be generated by any suitable device, such as a user device, a server, or any suitable combination thereof. In some embodiments, the virtual environment can be any virtual reality environment, any augmented reality environment, any video game environment, or any other computer-generated environment that can be interacted with by a user. In some embodiments, the virtual environment can have two or more spatial dimensions. Accordingly, positions within the virtual environment can have two or more dimensions. In some embodiments, the virtual environment can be stored in any suitable memory and/or storage capable of storing a virtual environment having two or more spatial dimensions. In some embodiments, the virtual environment can be a two-dimensional, two-and-a-half-dimensional, or three-dimensional virtual environment.

In some embodiments, a view frustum within the virtual environment can be generated, where the view frustum includes at least a region of the virtual environment that can be presented to a user. In some embodiments, a viewport of the virtual environment can be generated, where the viewport can include a projection of the region within the view frustum onto any surface. In some embodiments, the viewport can include a projection of the region within the view frustum onto any surface perpendicular to a viewing direction of a virtual camera in the virtual environment.

In some embodiments, the rendered screen of the virtual environment can be generated, where the rendered screen includes at least a portion of the viewport. In some embodiments, the rendered screen of the virtual environment and the viewport can be two-dimensional. Accordingly, positions in the rendered screen or positions in the viewport can be two-dimensional. In some embodiments, the rendered screen can include at least a portion of the content item if the content item is positioned in the view frustum. In some embodiments, the rendered screen can include any user interface elements. For example, in some embodiments, the user interface elements can include any elements, such as menus (e.g., main menus, pause menus, etc.), heads-up display (HUD) elements (e.g., health meters, experience meters, speed meters, etc.), timers, maps, compasses, cursors, reticles, crosshairs, inventory elements, etc., any text associated therewith, or any suitable combination thereof. In some embodiments, the user interface elements can be included in the rendered screen of the virtual environment whether or not the user interface elements are included in the view frustum of the virtual environment. In some embodiments, the rendered screen can be presented at any suitable device, such as a user device, a server, or any suitable combination thereof.

In some embodiments, the rendered screen of the virtual environment can include one or more visual elements positioned within the virtual environment. In some embodiments, the one or more visual elements can collide with casted rays. A casted ray is a virtual ray that can be generated within the virtual environment to collide with objects that are programmed to collide with casted rays, and that are positioned within a path of the casted ray. A collision between a casted ray and any object (including any visual element) within the virtual environment can indicate the position of the object along the path of the casted ray. In some embodiments, the one or more visual elements can obstruct the content item from the perspective of a virtual camera within the virtual environment. Accordingly, the mechanisms described herein can include determining whether a content item being presented within the virtual environment is being obstructed by the one or more visual elements by casting rays toward the content item. In some embodiments, the casted rays can be directed from the position of the virtual camera toward the content item.

However, in some embodiments, the virtual environment can include one or more visual elements that do not collide with one or more casted rays. Such visual elements can include particles, such as, for example, fog, smoke, steam, fire, rain, snow, debris, etc., or any other visual element that is configured to not to collide with one or more casted rays. In some embodiments, the rendered screen of the virtual environment can include visual elements, such as user interface elements that do not collide with one or more casted rays. Accordingly, the mechanisms described herein can include determining whether a content item being presented within the virtual environment is being obstructed by the one or more visual elements without casting any rays toward the content item in the virtual environment.

In some embodiments, even if one or more visual elements within the virtual environment can collide with casted rays, the mechanisms described herein can include determining whether a content item being presented within the virtual environment is being obstructed by the one or more visual elements without casting any rays toward the content item in the virtual environment.

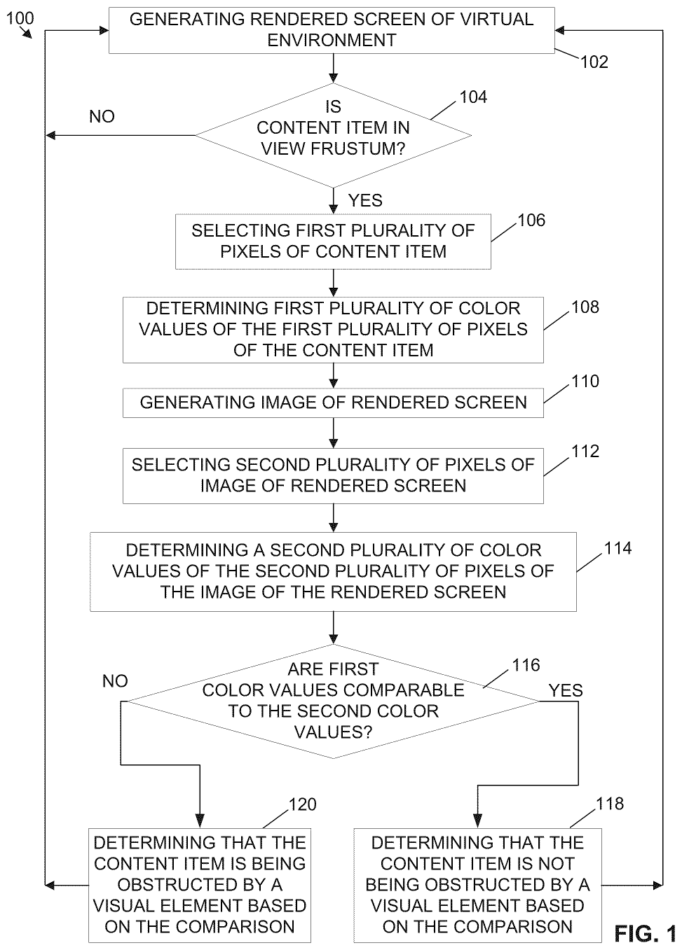

These and other features for determining viewability of a content item in a virtual environment having particles are further described in connection with FIGS. 1-8.

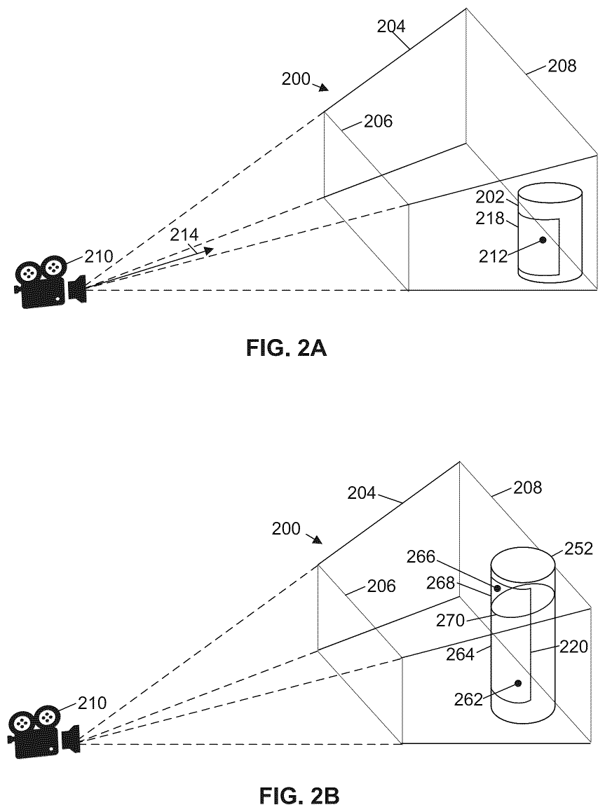

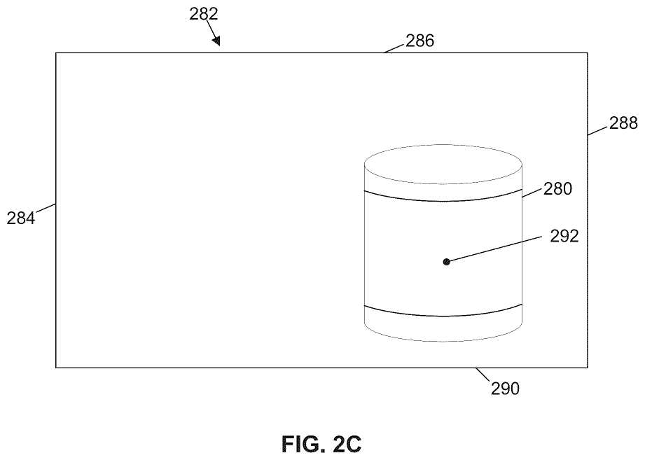

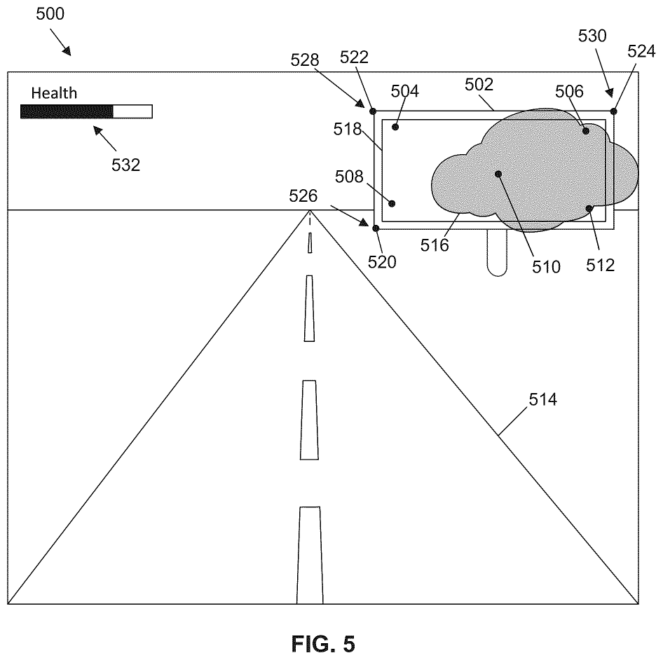

FIG. 1 shows an illustrative example of a process 100 for determining viewability of a content item in a virtual environment having particles and/or other visual elements in accordance with some embodiments of the disclosed subject matter. In some embodiments, a content item (e.g., a content item 218 in FIG. 2A, a content item 220 in FIG. 2B, a content item 518 in FIG. 5, etc.) can be presented within a virtual environment. As shown, process 100 can begin at 102 by generating a rendered screen of the virtual environment (e.g., an image 500 of a rendered screen in FIG. 5). In some embodiments, generating 102 the rendered screen can include generating a virtual camera (e.g., 210 in FIG. 2) and a view frustum (e.g., 200 in FIG. 2A) of the virtual camera in the virtual environment. In some embodiments, the view frustum can include a viewing region of the virtual environment. In some embodiments, generating 102 the rendered screen can include generating any user interface elements (e.g., 532 in FIG. 5) in the rendered screen.

In some embodiments, process 100 can include determining whether the content item is in the view frustum of the virtual environment at 104. This determination of whether the content item is in the view frustum at 104 can include any suitable processes, as described hereinbelow in connection with FIGS. 2A, 2B, and 2C.

In some embodiments, the virtual environment can be a dynamic virtual environment that changes with time. Accordingly, if the content item is determined not to be in the view frustum of the virtual environment at a first instance of time, process 100 can loop back to determining whether the content item is in the view frustum, and can proceed to any remaining subprocess of process 100 at any second instance of time. In some embodiments, process 100 can loop back to 104 to determine whether the content item is in the view frustum of the virtual environment, for example, at periodic intervals. The periodic intervals can be based on a frame rate (e.g., 30 Hz, 60 Hz, etc.) at which the rendered screen of the virtual environment is presented. For example, process 100 can loop back to 104 to determine whether the content item is in the view frustum at the same frame rate, or a multiple of the frame rate, in which the rendered screen of the virtual environment is presented.

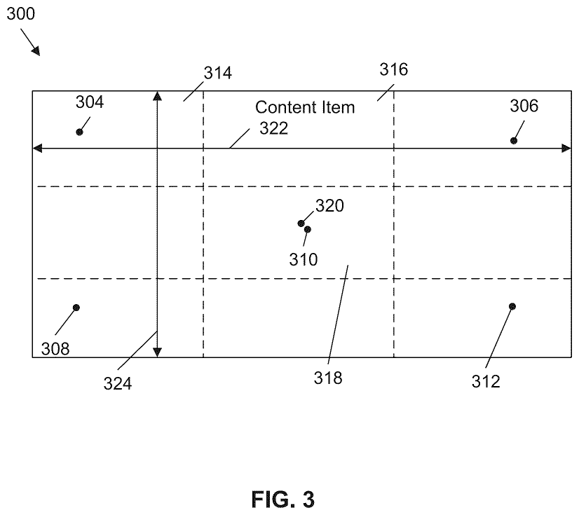

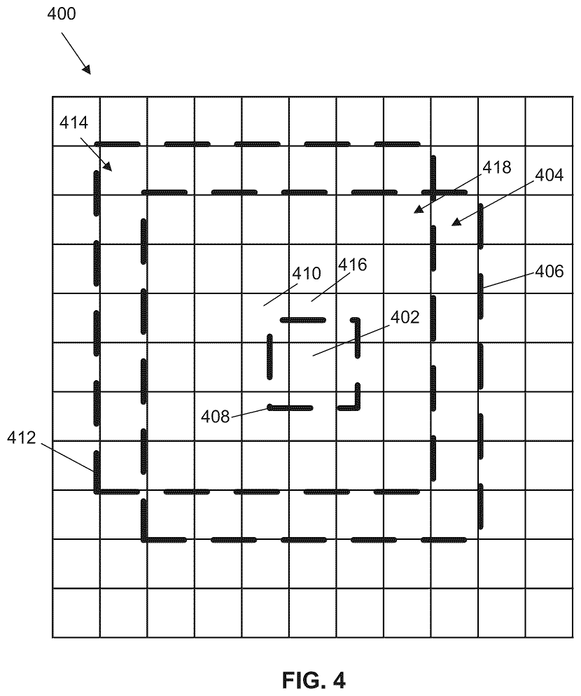

In some embodiments, in response to determining that the content item is in the view frustum of the virtual environment, process 100 can select a first plurality of pixels (e.g., pixels 304, 306, 308, 310, 312 in FIG. 3) of the content item at 106. In some embodiments, the first plurality of pixels can be a first subset of the pixels of the content item. In some embodiments, the first plurality of pixels can be selected as described hereinbelow in connection with FIGS. 3 and 4. In some embodiments, selecting the first plurality of pixels can include selecting memory and/or storage locations that store a first plurality of color values of the first plurality of pixels of the content item.

In some embodiments, in response to selecting the first plurality of pixels of the content item, process 100 can determine a first plurality of color values of the first plurality of pixels of the content item at 108. In some embodiments, the intensity of each color of any pixel of the content item can be determined by any suitable color value in any suitable range. Further, a pixel can have any suitable colors.

In some embodiments, each pixel of the content item can be associated with any suitable combination of color values. For example, color values can include a red value, a green value, a blue value, a cyan value, a magenta value, a yellow value, a black value, a white value, etc., or any suitable combination thereof. As another example, a suitable combination of color values can include 1) red, green, blue (RGB) values, 2) cyan, magenta, yellow, and black (CMYK) color values, 3) grayscale values, etc., or any suitable combination thereof. Each color value (e.g., red color value, green color value, cyan color value, black color value, etc.) can indicate the intensity of a respective color of a pixel of the content item. Further, if a pixel includes subpixels, each color value can indicate the intensity of a color of a respective subpixel of a pixel of the content item. For example, as the intensity of each RGB color value can be represented by a number in any suitable range, such as the range from 0 to 255, a white RGB pixel can be represented by RGB values (255, 255, 255). In continuing this example, a black RGB pixel can be represented by RGB values (0, 0, 0). In further continuing this example, a red RGB pixel can be represented by RGB values (255, 0, 0). However, the same pixels can be represented by different color values (e.g., CMYK color values, grayscale color values, etc.), and by different numbers of color values in some embodiments.

The first plurality of color values of the first plurality of pixels can be determined by reading any suitable memory and/or storage location(s) containing the content item, including any suitable memory and/or storage containing the virtual environment that includes the content item. In some embodiments, the color values of the pixels of the content item can be stored in any suitable format. As an example, the color values of the pixels of the content item can be stored as an array of color values, or as a plurality of arrays of color values, and the color values of each pixel can be determined by reading color values stored at respective locations in the array(s), according to some embodiments of the disclosed subject matter.

In some embodiments, process 100 can, at 110, generate a first image of the rendered screen of the virtual environment (e.g., an image 500 in FIG. 5). In some embodiments, generating the rendered screen of the virtual environment can include generating the first image of the rendered screen. In some embodiments, process 100 can include generating images of the rendered screen of the virtual environment at a predetermined frame rate.

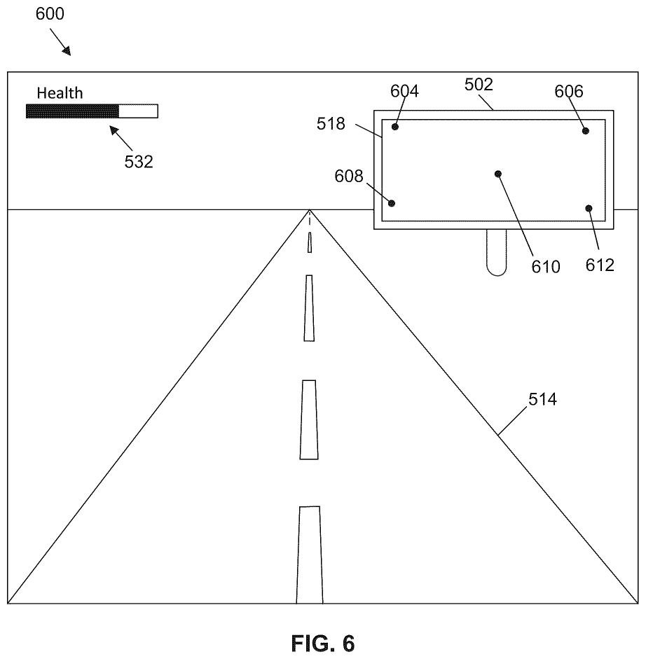

In some embodiments, process 100 can, at 112, select a second plurality of pixels (e.g., pixels 504, 506, 508, 510, and 512 in FIG. 5) of the image of the rendered screen of the virtual environment. In some embodiments, the second plurality of pixels can be a second subset of the pixels of the image of the rendered screen. In some embodiments, the second plurality of pixels can be selected as described hereinafter in connection with FIGS. 5 and 6.

In some embodiments, process 100 can, at 114, determine a second plurality of color values of the second plurality of pixels of the image of the rendered screen of the virtual environment. In some embodiments, the pixels of the image of the rendered screen can be associated with any suitable combination of color values. In some embodiments, the image of the rendered screen of the virtual environment can be stored in any suitable memory and/or storage, including any suitable memory and/or storage that contains the virtual environment. Accordingly, the second plurality of color values can be determined by reading any suitable memory and/or storage containing the image of the rendered screen of the virtual environment.

In some embodiments, process 100 can, at 116, compare the first plurality of color values with the second plurality of color values. In some embodiments, comparing the first plurality of color values with the second plurality of color values can include determining whether the first plurality of color values and the second plurality of color values are approximately the same. In some embodiments, comparing the first plurality of color values with the second plurality of color values can include determining a proportion of the first plurality of color values that are determined to be the same as the second plurality of color values. Any suitable processes can be performed to compare the first plurality of color values with the second plurality of color values. For example, comparing the color values can include determining differences between any of the first plurality of color values and any of the second plurality of color values, summing the differences, summing weighted differences, determining a mean of the differences, determining quotients between any of the first plurality of color values and any of the second plurality of color values, summing the quotients, summing weighted quotients, determining a mean of the quotients, determining a mean squared error between the first plurality of color values and the second plurality of color values, determining a root mean squared error between the first plurality of color values and the second plurality of color values, any other suitable process that can compare the first plurality of color values and the second plurality of color values, or any suitable combination thereof.

In some embodiments, process 100 can include determining a value (e.g., proportion) representing a comparison between the first plurality of color values and the second plurality of color values. In some embodiments, process 100 can include determining any suitable predetermined range of values and/or any suitable predetermined threshold that defines the predetermined range of values, and determining whether the first plurality of color values and the second plurality of color values are approximately the same based on the predetermined range of values and/or predetermined threshold that defines the predetermined range of values. In some embodiments, the value representing a comparison between the first plurality of color values and the second plurality of color values can be compared to the predetermined range of values and/or predetermined threshold to determine whether the first plurality of color values and the second plurality of color values are approximately the same.

In some embodiments, the first plurality of color values can have a different range of values when compared to the second plurality of color values, due to, for example, differences in the format in which the color values are stored. Accordingly, in some embodiments, comparing the first plurality of color values with the second plurality of color values can include converting the first plurality of color values and/or the second plurality of color values so that the first plurality of color values and the second plurality of color values have the same format.

In some embodiments, the content item in the rendered screen is not overlaid with any visual element. Accordingly, in some embodiments, the first plurality of color values and the second plurality of color values can be determined to be approximately the same. In response to determining that the first plurality of color values and the second plurality of color values are approximately the same, process 100 can, at 118, determine that the content item being presented within the virtual environment is not being obstructed by a visual element based on the comparison. In some embodiments, in response to determining that the content item being presented within the virtual environment is not being obstructed by a visual element at 118, process 100 can determine that a user viewed the content item.

In some embodiments, the content item in the rendered screen can be overlaid with at least one visual element. Accordingly, in some embodiments, the first plurality of color values and the second plurality of color values can be determined not to be approximately the same. In response to determining that the first plurality of color values and the second plurality of color values are not approximately the same, process 100 can determine, at 118, that the content item being presented within the virtual environment is being obstructed by a visual element in the rendered screen based on the comparison.

In some embodiments, process 100 can loop back to any subprocess of process 100, and can proceed to any remaining subprocesses of process 100.

In some embodiments, process 100 can further include counting a first number of determinations that the content item being presented within the virtual environment is not being obstructed by a visual element over a predetermined time period. In some embodiments, process 100 can include counting a second number of determinations that the content item being presented within the virtual environment is being obstructed by a visual element over the predetermined time period. In some embodiments, process 100 can include comparing the first number of determinations to the second number of determinations. In some embodiments, process 100 can include determining a ratio between the first and second numbers of determinations. In some embodiments, process 100 can include determining a ratio between the first number of determinations and the total number of determinations (e.g., sum of the first and second numbers of determinations) during the predetermined time period.

In some embodiments, process 100 can further include making consecutive determinations that color values of pluralities of pixels of consecutively generated images of rendered screens are approximately the same as the color values of the first plurality of pixels. In some embodiments, process 100 can include making consecutive determinations that the content item being presented within the virtual environment is not being obstructed by a visual element over a predetermined time period. Based on the consecutive determinations, process 100 can include determining that a user viewed the content item. In response to determining that a user viewed the content item, process 100 can include associating the content item with an impression, and storing a record of the impression. Additional views can be determined based on any additional consecutive determinations that the content item being presented within the virtual environment is not being obstructed by a visual element over the predetermined time period. Any additional impressions can be associated with the content item and stored.

In some embodiments, process 100 can further include making consecutive determinations that color values of pluralities of pixels of consecutively generated images of the virtual environment are not approximately the same as the color values of the first plurality of pixels. In some embodiments, process 100 can include making consecutive determinations that the content item being presented within the virtual environment is being obstructed by a visual element over a predetermined time period.

FIG. 2A shows an example diagram of a mechanism for determining whether a content item 218 is in a view frustum 200 of a virtual environment in accordance with some embodiments of the disclosed subject matter. In some embodiments, the content item 218 can be included in, or attached to, a content item object 202. In some embodiments, the view frustum 200 can include a viewing region in the virtual environment. As shown, in some embodiments, the view frustum 200 can be a truncated pyramid. However, the view frustum 200 can have any suitable shape, such as a pyramid, a cone, any other suitable shape that can be used to define a view region in the virtual environment, any truncated forms thereof, and any suitable combination thereof, according to some embodiments. As shown in FIGS. 2A and 2B, the view frustum can have surface(s) 204 that converge to a virtual camera 210 having a viewing direction 214. The view frustum 200 can have any suitable length in the virtual environment, including an infinite length, or any other suitable predetermined length. In some embodiments, the length of the frustum can be determined by the distance from a first clipping surface 206 to a second clipping surface 208. In some embodiments, the first clipping surface 206 can be a first (e.g., near) clipping plane, and the second clipping surface 208 can be a second (e.g., far) clipping plane. In some embodiments, the viewing direction 214 of the camera 210 can be perpendicular to the first 206 and/or second 208 clipping surfaces. In some embodiments, the first clipping surface 206 can be positioned at any distance between a virtual camera 210 and the second clipping surface 208. In some embodiments, the second clipping surface 208 can be positioned at any distance from the first clipping surface. As shown, the surface(s) 204 can extend from the first clipping surface 206 to the second clipping surface 208. In some embodiments, the first 206 and second 208 clipping surfaces, and the surface(s) 204 can be the boundaries of the view frustum within the virtual environment.

In some embodiments, the mechanisms described herein can include determining whether the content item 218 is in the view frustum 200 of the virtual environment. In some embodiments, determining whether the content item 218 is in the view frustum can include any suitable processes. In some embodiments, determining whether the content item 218 is in the view frustum can include determining whether the content item object 202 is in the view frustum. In some embodiments, determining whether the content item 218 is in the view frustum can include determining a first position 212 (e.g., a two-dimensional position or a three-dimensional position) at the content item 218 within the virtual environment. Based on this determination, the first position 212 at the content item 218 can be compared to the boundaries of the view frustum to determine whether the first position at the content item 218 is in the view frustum 200 of the virtual environment. As shown in FIG. 2A, the first position 212 can be within the boundaries of the view frustum. Accordingly, in some embodiments, it can be determined that the content item 218 is in the view frustum 200 of the virtual environment.

Turning to FIG. 2B, an example diagram of a mechanism for determining whether a second content item 220 is in the view frustum 200 of a virtual environment is shown in accordance with some embodiments of the disclosed subject matter. In some embodiments, the second content item 220 can be included in, or attached to, a second content item object 252. In some embodiments, as shown in FIG. 2B, the second content item 220 can be partially in the view frustum 200. In particular, a first portion 264 of the second content item 220 can be positioned in the view frustum 200, and a second portion 266 of the second content item 220 can be positioned outside the view frustum 200. For example, as shown in FIG. 2B, the second content item 220 can intersect a surface 204 of the view frustum along intersection 270 between the content item object 252 and a surface 204 of the view frustum 200. As also shown in FIG. 2B, a first position 262 at the second content item 220 can be within the boundaries of the view frustum 200. A second position 266 at the second content item 220 can be determined to not be within the boundaries of the second view frustum 250. In some embodiments, if at least one position at a content item 220 is in the view frustum, the mechanisms described herein can determine that the content item 220 is in the view frustum. Accordingly, since the first position 262 at the second content item 220 is in the view frustum 200, it can be determined that the second content item 220 is in the view frustum.

FIG. 2C shows an example diagram of a mechanism for determining whether a content item 280 is in a viewport 282 of a virtual environment in accordance with some embodiments of the disclosed subject matter. In some embodiments, the viewport 282 can include a projection of a region in a view frustum onto a surface perpendicular to a viewing direction of a virtual camera. In some embodiments, determining whether the content item is in the view frustum can include determining whether the content item 280 is within boundaries 284, 286, 288, 290 of the viewport of the virtual environment. Any suitable processes can be used to make this determination. In some embodiments, determining whether the content item 280 is within the boundaries 284, 286, 288, 290 of the viewport 282 can include determining a first position (e.g., position 212 in FIG. 2A, and/or positions 262 and 266 in FIG. 2B) at the content item 280 within the virtual environment (e.g., which can be a two-dimensional position or a three-dimensional position). Based on this determination, the mechanisms described herein can determine a second position 292 (e.g., a two-dimensional position) at the content item as projected onto the surface of the viewport 282. In some embodiments, the second position 292 can be compared to the boundaries 284, 286, 288, 290 of the viewport to determine whether the second position 292 at the content item is within the boundaries of the viewport of the virtual environment. If at least one position at the content item (e.g., second position 292) is within the boundaries of the viewport 282, it can be determined that the content item 280 is in the view frustum of the virtual environment. Otherwise, it can be determined that the content item 280 is not in the view frustum of the virtual environment.

FIG. 3 shows an example diagram of a mechanism for selecting a first plurality of pixels of a content item 300 in accordance with some embodiments of the disclosed subject matter. While five selected pixels 304, 306, 308, 310, and 312 are shown in FIG. 3, any suitable number of pixels of the content item 300 can be selected in some embodiments. In some embodiments, pixels of the content item 300 can be selected based on positions of the pixels. In some embodiments, the positions of the pixels of the content item can be positions of the pixels on a rendered screen of the virtual environment, positions of the pixels within the content item, positions of the pixels within the content item as projected onto any surface, or any suitable combination thereof. In some embodiments, the positions of the pixels can be two-dimensional positions.

In some embodiments, the positions of the pixels can be determined by selected positions (e.g., position 212 in FIG. 2A and/or positions 262 and 266 in FIG. 2B) at the content item 300 within the virtual environment, where the selected positions have the same number of dimensions as the virtual environment. In some embodiments, selecting the first plurality of pixels of the content item 300 can include projecting the selected positions at the content item 300 within the virtual environment to respective positions onto any surface (e.g., of the viewport of the virtual environment), and selecting the first plurality of pixels located at the respective positions of the surface.

As shown in FIG. 3, pixels positioned along a majority of the length 322 of the content item 300 can be selected. As also shown in FIG. 3, at least one pixel 310 positioned proximate to a center 320 of the content item 300 can be selected. In some embodiments, a pixel proximate to the center 320 can be a pixel located at the center 320 of the content item 300.

In some embodiments, selecting the first plurality of pixels can include determining two or more distinct regions 314, 316, 318, etc. of the content item. In some embodiments, the two or more regions 314, 316, 318, etc. can be determined based on the colors of the pixels of the content item. In some embodiments, the two or more regions 314, 316, 318, etc. can be distinct regions of color in the content item 300. In some embodiments, any suitable process, including for example implementing a machine learning model, can be performed to determine the colors of the pixels of the content item, and determine two or more distinct regions based on the colors of the pixels of the content item.

In some embodiments, the two or more regions 314, 316, 318, etc. can be determined based on the dimensions of the content item 300. In some embodiments, determining the two or more regions can include dividing a first dimension (e.g., length 322) of the content item by any suitable first number, dividing a second dimension (e.g., height 324) of the content item by any suitable second number, and determining the two or more regions based on the divisions.

While nine regions of approximately the same size are shown in FIG. 3, in some embodiments, any suitable number of regions of approximately the same size or any suitable number of regions of different sizes can be determined. While the two or more regions 314, 316, 318, etc. are shown as being rectangular, the two or more regions can have any shape. For example, the two or more regions 314, 316, 318, etc. can be triangular, square, polygonal, circular, elliptical, etc., or any suitable combination thereof. In continuing this example, the two or more regions can have any suitable irregular shape.

As shown, pixels 304, 306, 308, 310, and 312 in respective regions of the content item 300 can be selected. As shown, at least one pixel 310 positioned proximate to a center 320 of a respective region 318 of the content item 300 can be selected. In some embodiments, any pixels of the content item located at any positions can be selected as the first plurality of pixels. In some embodiments, any pixels of the content item can be randomly selected as the first plurality of pixels.

Turning to FIG. 4, an example diagram of a mechanism for selecting one or more pixels within a region 400 of pixels of a content item is shown in accordance with some embodiments of the disclosed subject matter. In some embodiments, any pixels located at any positions within region 400 can be selected as selected pixels of a first plurality of selected pixels (e.g., pixels 304, 306, 308, 310, and 312 in FIG. 3). In some embodiments, region 400 can be a region of the content item, a region of the content item as presented on a rendered screen, or any region onto which the content item in a virtual environment is projected. While the shown pixels of the content item are represented in a square arrangement, the pixels of the content item can be represented in any suitable pixel geometric arrangement. For example, suitable pixel geometric arrangements can include triangular arrangements, rectangular arrangements, polygonal arrangements, circular arrangements, elliptical arrangements, etc., or any suitable combination thereof. In some embodiments, suitable geometric arrangements can include irregular geometric arrangements. Further while the pixels are shown having a square shape, the pixels can have any suitable shape, such as triangular, rectangular, polygonal, circular, elliptical, etc., or any suitable combination thereof. In some embodiments, the pixels can have irregular shapes.

As shown, the region 400 of pixels includes a reference pixel 402 and first proximate pixels 404 proximate to the first reference pixel 402. The mechanisms described herein can include selecting the first reference pixel 402 and the proximate pixels 404. In some embodiments, the first reference pixel 402 can be any pixel located at any position of the content item. The mechanisms described herein can include comparing the first reference pixel 402 and the first proximate pixels 404 to determine whether the first reference pixel 402 can be selected as a selected pixel of a first plurality of selected pixels (e.g., 304, 306, 308, 310, and 312 in FIG. 3).

In some embodiments, the first proximate pixels 404 can be any pixels proximate to the first reference pixel 402. In some embodiments, the first proximate pixels 404 can be selected by selecting any pixels positioned within a predetermined number of pixels relative to the first reference pixel 402. In some embodiments, the first proximate pixels 404 can be selected by creating a boundary 406 around the reference pixel 402. As shown, the boundary 406 can indicate which pixels are positioned within the predetermined number of pixels relative to the reference pixel 402. While a square boundary 406 is shown, the boundary 406 can have any suitable shape, such as triangular, rectangular, polygonal, circular, elliptical, etc., or any suitable combination thereof. In some embodiments, the boundary 406 can have any suitable irregular shape. While the proximate pixels 404 are shown positioned within three pixels relative to the reference pixel 402, in some embodiments, the proximate pixels 404 can be positioned within any suitable predetermined number of pixels (e.g., such as one pixel, two pixels, three pixels, etc.) relative to the reference pixel 402.

In some embodiments, if the first reference pixel 402 and the first proximate pixels 404 are approximately the same in color, the reference pixel can be selected as a selected pixel of a first plurality of selected pixels (e.g., 304, 306, 308, 310, and 312 in FIG. 3).

The mechanisms described herein can include determining whether the first reference pixel 402 and the first proximate pixels 404 are approximately the same in color. In some embodiments, the color values of the reference pixel 402 can be compared with the color values of each pixel 404 proximate to the reference pixel 402. Any suitable process can be performed to compare the color values of the reference pixel 402 and the color values of each proximate pixel 404. For example, comparing the color values can include determining a difference between any color values of the reference pixel 402 and any color values of each proximate pixel 404, summing the differences, summing weighted differences, determining a mean of the differences, determining a quotient between any color values of the reference pixel 402 and any color values of each proximate pixel 404, summing the quotients, summing weighted quotients, determining a mean of the quotients, determining a mean squared error between the color values of the proximate pixels 404 and the color values of the reference pixel 402, determining a root mean squared error between the color values of the proximate pixels 404 and the color values of the reference pixel 402, any other suitable process that can compare the color values of the reference pixel 402 and the color values of each proximate pixel 404, or any suitable combination thereof. In some embodiments, the mechanisms can include determining a value representing a comparison between the color values of the reference pixel 402 and the color values of the proximate pixels 404.

Based on the comparison between the color values of the first reference pixel 402 and the color values of each proximate pixels 404, the mechanisms described herein can include determining that the first reference pixel 402 and the proximate pixels 404 are approximately the same in color, or determining that the reference pixel 402 and the proximate pixels 404 are not approximately the same in color. In some embodiments, these determinations can be based on a predetermined range of values and/or a predetermined threshold that defines the predetermined range of values. For example, if the value representing the comparison is within a predetermined range of values, the reference pixel 402 and the proximate pixels 404 can be determined to be approximately the same in color. If the reference pixel 402 and the proximate pixels 404 are determined to be approximately the same in color, the reference pixel 402 can be selected as a selected pixel of a first plurality of selected pixels (e.g., 304, 306, 308, 310, and 312 in FIG. 3).

In some embodiments, however, the mechanisms described herein can include determining that the first reference pixel 402 and the proximate pixels 404 are not approximately the same in color. If the reference pixel 402 and the proximate pixels 404 are determined to not be approximately the same in color, the mechanisms described herein can include selecting a second reference pixel 410, where the second reference pixel 410 is different than the first reference pixel 402.

As shown in FIG. 4, the second reference pixel 410 can be positioned proximate to the first reference pixel 402. While the second reference pixel 410 is shown positioned within one pixel relative to the first reference pixel 402, the second reference pixel 410 can be positioned within any suitable number of pixels (e.g., such as one pixel, two pixels, three pixels, etc.) relative to the first reference pixel 402. As shown, the second reference pixel 410 can be positioned along a first perimeter 408 created around the first reference pixel 402. While the first perimeter 408 is shown positioned along pixels positioned within one pixel relative to the first reference pixel 402, the first perimeter 408 can be positioned along pixels positioned within any suitable number of pixels (e.g., such as one pixel, two pixels, three pixels, etc.) relative to the first reference pixel 402. While the first perimeter 408 is shown having a square shape, the first perimeter 408 can have any suitable shape, such as triangular, rectangular, polygonal, circular, elliptical, etc., or any suitable combination thereof. Further, the first perimeter can have any suitable irregular shape.

In some embodiments, as shown in FIG. 4, the first proximate pixels 404 can be proximate to the second reference pixel 410. Accordingly, the mechanisms described herein can include determining whether the second reference pixel 410 and the first proximate pixels 404 are approximately the same in color. If the second reference pixel 410 and the first proximate pixels 404 are determined to be approximately the same in color, mechanisms described herein can include selecting the second reference pixel 410 as a selected pixel of a first plurality of selected pixels (e.g., 304, 306, 308, 310, and 312 in FIG. 3).

In some embodiments, whether or not the first proximate pixels 404 are proximate to the second reference pixel 410, the mechanisms described herein can include selecting second proximate pixels 414 different from the first proximate pixels 404, the second proximate pixels 414 being proximate to the second reference pixel 410. In some embodiments, as shown, the first proximate pixels 404 and the second proximate pixels 414 can include at least a portion 418 of pixels in common.

In some embodiments, the second proximate pixels 414 can be selected in the same or similar manner as the first proximate pixels were selected. For example, the second proximate pixels 414 can be selected by selecting any pixels positioned within a second predetermined number of pixels relative to the second reference pixel 414. In some embodiments, the second proximate pixels 414 can be selected by creating a second boundary 412 around the second reference pixel 410. As shown, the second boundary 412 can indicate which pixels are positioned within the second predetermined number of pixels relative to the second reference pixel 410. While a square boundary 412 is shown, any suitable closed boundary shape can be used as boundary 412. While the second proximate pixels 414 are shown positioned within three pixels relative to the second reference pixel 410, in some embodiments, the second proximate pixels 414 can be positioned within any suitable predetermined number of pixels relative to the second reference pixel 410.

The mechanisms described herein can include determining whether the second reference pixel 410 and the second proximate pixels 414 are approximately the same in color. If the second reference pixel 410 and the second proximate pixels 414 are determined to be approximately the same in color, the mechanisms described herein can include selecting the second reference pixel 410 as a selected pixel of a first plurality of selected pixels (e.g., pixels 304, 306, 308, 310, and 312 in FIG. 3).

If the second reference pixel 410 and the second proximate pixels 414 are determined not to be approximately the same in color, the mechanisms described herein can include selecting a third reference pixel 416, the third reference pixel being different than the first 402 and second 410 reference pixels. In some embodiments, the third reference pixel 416 can be positioned proximate to the first reference pixel 402. As shown, the third reference pixel 416 can be positioned along the first perimeter 408.

In some embodiments, the mechanisms described herein can include determining whether the third reference pixel 416 and third proximate pixels (not labelled) proximate to the third reference pixel 416 are approximately the same in color. Any additional reference pixel positioned along perimeter 408 can be selected to determine whether this additional reference pixel is approximately the same in color with a plurality of pixels proximate to it. If any additional reference pixel is determined to be approximately the same in color with a plurality of pixels proximate to it, any additional reference pixel can be selected as a selected pixel of a first plurality of pixels. If all pixels positioned along perimeter 408 are determined not to be approximately the same in color with pluralities of pixels proximate to them, any additional perimeters around the first reference pixel 402 can be created to select any additional reference pixels positioned along any additional perimeters, according to some embodiments of the disclosed subject matter.

In some embodiments, ensuring that each pixel in a first plurality of pixels of a content item is approximately the same in color with pixels proximate to it can improve a comparison between the first plurality of pixels and a second plurality of pixels of a rendered screen of a virtual environment. For example, more pixels of the first plurality of pixels can be determined to be approximately the same in color with more pixels of the second plurality of pixels, according to some embodiments.

FIG. 5 shows an example mechanism for comparing a second plurality of pixels 504, 506, 508, 510, and 512 of a first image 500 of a rendered screen of a virtual environment with a first plurality of pixels (e.g. 304, 306, 308, 310, and 312 in FIG. 3) of a content item 518 in accordance with some embodiments of the disclosed subject matter. In some embodiments, the first image 500 of the rendered screen can be captured while the virtual environment changes with time. For example, the first image 500 of the rendered screen can be captured while a user is controlling a virtual camera in the virtual environment. In some embodiments, the first image 500 of the rendered screen can be captured within a predetermined amount of time from when a user moves the virtual camera in the virtual environment, thereby changing a position and/or orientation of a view frustum of the virtual environment.

As shown, in some embodiments, any suitable virtual objects positioned within the view frustum of the virtual environment can be presented on the rendered screen of the virtual environment. As shown, the virtual environment can be three-dimensional, and can include any suitable virtual objects such as a content item object 502, a virtual road 514, or a combination thereof, positioned within the view frustum. In some embodiments, the content item object 502 can include, or be attached to, a content item 518 such as an image, a video, a frame of a video, a sequence of frames of a video, etc., or any suitable combination thereof. In some embodiments, the content item 518 can include text, graphics, symbols, logos, etc. that can be used to advertise a particular company, brand, product, service, etc.

As shown, the content item object 502 can include any suitable virtual object for advertising a company, brand, product, service, etc. As shown, in some embodiments, the content item object 502 can be a virtual billboard. However, in other embodiments, the content item object 502 can include any other suitable virtual object. In some embodiments, the content item object 502 can include a virtual sign, poster, sticker, printed material, etc., or any suitable combination thereof. In some embodiments, the content item object 502 can include any suitable virtual display devices, such as a virtual touchscreen, flat-panel display, cathode ray tube display, projector system, any other suitable display and/or presentation devices, etc., or any suitable combination thereof. In some embodiments, the content item object 502 can be presented as a two-dimensional or three-dimensional object. In some embodiments, the virtual content item object 502 can include a hologram. In some embodiments, the content item object 502 can be presented on or in any two-dimensional or three-dimensional object within the virtual environment.

As shown, the content item object 502 can be positioned proximate to the virtual road 514. However, in other embodiments, the content item object 502 can be positioned proximate to any other virtual object(s) in the virtual environment. In some embodiments, the content item object 502 can be positioned at any position that can be viewed by a virtual camera within the virtual environment.

The mechanisms described herein can include selecting the second plurality of pixels 504, 506, 508, 510, and 512 of the image 500 of the rendered screen of the virtual environment. While five pixels 504, 506, 508, 510, and 512 are shown in FIG. 5, any suitable number of pixels of the image 500 of the rendered screen can be selected in some embodiments. Any suitable process can be used to make the selection of the second plurality of pixels.

In some embodiments, the second plurality of pixels of the image 500 of the rendered screen can be selected to correspond to respective pixels of a first plurality of pixels (e.g. 304, 306, 308, 310, and 312 in FIG. 3) of the content item 518. In some embodiments, the second plurality of pixels of the image 500 of the rendered screen can be selected based on (e.g., two-dimensional) positions of the first plurality of pixels within the content item 518.

In some embodiments, the second plurality of pixels of the image 500 of the rendered screen can be selected based on selected (e.g., two-dimensional or three-dimensional) positions (e.g., 212 in FIG. 2A, 262 in FIG. 2B) at the content item 518 within the virtual environment. In some embodiments, selecting the second plurality of pixels of the image 500 can include projecting selected positions (e.g., 212 in FIG. 2A, 262 in FIG. 2B) at the content item 518 to respective positions on the rendered screen of the virtual environment, and selecting the second plurality of pixels located at the respective positions on the rendered screen of the virtual environment.

In some embodiments, the first plurality of pixels of the content item 518 can be mapped onto respective positions in the virtual environment based on an orientation and position(s) of the content item object 502 in the virtual environment. In some embodiments, the content item object 502 can be generated so that portions of the content item object 502 within the virtual environment are located at a first predetermined position 520, a second predetermined position 522, a third predetermined position 524, etc., or any suitable combination thereof. In some embodiments, the boundaries of the content item object 502 within the virtual environment can be located at one or more of the first 520, second 522, and third 524 predetermined positions. In some embodiments, the first 520, second 522, and third 524 predetermined positions can define boundaries of the content item object 502. In some embodiments, the first predetermined position 520 can be located at an upper boundary and left boundary of the content item object 502. In some embodiments, the second predetermined position 522 can be located at the left boundary and lower boundary of the content item object 502. In some embodiments, the third predetermined position 524 can be located at the upper and right boundaries of the content item object 502. In some embodiments, the first plurality of pixels can be mapped onto respective positions in the virtual environment based on the boundaries of the content item object 502 within the virtual environment.

In some embodiments, the first plurality of pixels can be mapped onto respective positions in the virtual environment based on comparison of an orientation of the content item object 502 in the virtual environment and an orientation of a virtual camera in the virtual environment. In some embodiments, the rendered screen of the virtual environment can include at least a portion of a viewport of the virtual environment, which can present a region of the virtual environment from a perspective of a camera position of the virtual camera. In some embodiments, the first 520, second 522, and third 524 predetermined positions can determine an orientation of the content item object 502 within the virtual environment. In some embodiments, the first 520, second 522, and third 524 predetermined positions can define a plane parallel to a surface of the content item object 502, thereby defining an orientation of the content item object 502.

In some embodiments, the orientation of the camera can be determined by a viewing direction of the virtual camera within the virtual environment, a plane perpendicular to the viewing direction of the camera, any clipping surface of the view frustum, any other suitable vector or plane that can determine the orientation of the view of the camera, or any suitable combination thereof.

In some embodiments, the orientation of any object in the virtual environment, including the content item object 502 and the camera in the virtual environment, can be determined by any suitable vectors, planes, angles, complex numbers, quaternions, etc., or any suitable combination thereof. Suitable vectors or planes can include any vector or plane perpendicular to any surface of an object, any vector or plane parallel to any surface of an object, or any suitable combination thereof. In some embodiments, the virtual environment can include any suitable number of coordinate axes. In some embodiments, the virtual environment can include any suitable type of coordinate axes, such as cartesian coordinate axes, spherical coordinate axes, cylindrical coordinate axes, etc., or any suitable combination thereof. In some embodiments, each object of the virtual environment can be associated with a respective set of coordinate axes.

In some embodiments, mapping the positions of the first plurality of pixels of the content item 518 can be based on a relative scale of the content item object 502 in the virtual environment relative to a camera position of a virtual camera within the virtual environment. In some embodiments, the first 520, second 522, and third 524 predetermined positions of the content item object 502 can determine a size of the content item object 502 in the virtual environment. In some embodiments, the relative scale can be determined by determining distances to one or more of the first 520, second 522, and third 524 predetermined positions at the content item object 502 within the virtual environment.

The mechanisms described herein can include comparing color values of a first plurality of pixels (e.g. 304, 306, 308, 310, and 312 in FIG. 3) of the content item 518 with color values of the second plurality of pixels (504, 506, 508, 510, and 512) of the image 500 of the rendered screen.

As shown, first visual elements such as user interface elements 532 can be positioned in the rendered screen. As shown, the user interface elements 532 can include a health meter and associated text. As shown, the user interface elements 532 do not obstruct the content item 518 in the image 500 of the rendered screen. However, in other embodiments, the user interface elements 532 can at least partially obstruct a portion of the content item 518 in the image 500 of the rendered screen of the virtual environment.

As shown, a second visual element 516 can at least partially obstruct the content item 518 in the image 500 of the rendered screen. The second visual element 516 can be any visual element that can at least partially obstruct the content item 518 when presented on a rendered screen. For example, in some embodiments, the visual element can include a virtual particle system such as a virtual cloud, fog, smoke, steam, fire, rain, snow, debris, etc., or any other visual element that can at least partially obstruct the content item 518 when the content item 518 is presented on a rendered screen. In other embodiments, the second visual element 516 can include any user interface elements.

In some embodiments, the color(s) of the visual element 516 can be different from the color(s) of the content item 518. Accordingly, as the visual element 516 is at least partially covering the content item 518, the color values of at least a first set of pixels (e.g., pixels 506, 510, 512) of the second plurality of pixels of the first image 500 of the rendered screen can be determined to be approximately not the same as color values of respective pixels of the first plurality of pixels. In response, mechanisms according to some embodiments can include determining that the content item 518 being presented within the virtual environment is being obstructed by the visual element 516 based on the comparison of the color values. While three pixels (e.g., pixels 506, 510, 512) are shown to be different in color, mechanisms according to some embodiments can include determining that the content item 518 is being obstructed if any suitable number of pixels of the second plurality of pixels are determined to be different in color than respective pixels of the first plurality of pixels.

In some embodiments, the visual element 516 can be deleted or moved relative to the content item object 502. FIG. 6 shows a second image 600 of a second rendered screen of the virtual environment which is the same as the first image 500 shown in FIG. 5, except that the second image 600 does not show the visual element 516. Accordingly, in some embodiments, the visual element 516 does not obstruct the content item 518 in the image 600 of the rendered screen of the virtual environment. In other embodiments, the position of the content item 518 on the rendered screen can change relative to the visual element 516 as the perspective of the virtual camera changes. Accordingly, in other embodiments, the visual element may not obstruct the content item 518 on the rendered screen after the position and/or orientation of the virtual camera changes.

As the visual element 516 is not obstructing the content item 518 in the image 600, the color values of the second plurality of pixels 604, 606, 608, 610, 612 of the second image 600 of the rendered screen can be determined to be approximately the same as the color values of respective pixels of the first plurality of pixels. In response, mechanisms according to some embodiments can include determining that the content item 518 being presented within the virtual environment is not being obstructed by a visual element based on the comparison of the color values in the image 600.

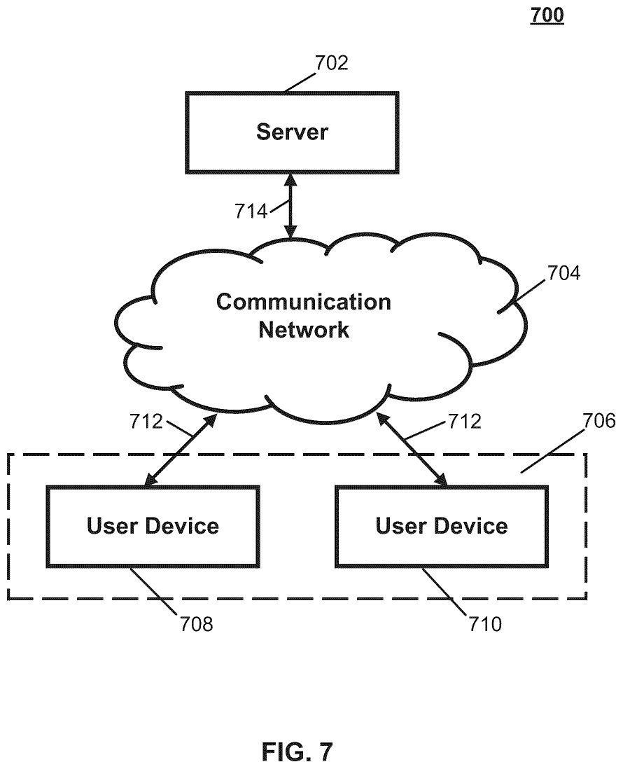

Turning to FIG. 7, an example system 700 for determining viewability of a content item in accordance with some embodiments is shown. As illustrated, system 700 can include a server 702, a communication network 704, one or more user devices 706 (e.g., such as user devices 708 and 710), or any suitable combination thereof.

Server 702 can be any suitable server(s) for storing information, data, programs, media content, and/or any other suitable content. In some embodiments, server 702 can perform any suitable function(s).

Communication network 704 can be any suitable combination of one or more wired and/or wireless networks in some embodiments. For example, communication network can include any one or more of the Internet, an intranet, a wide-area network (WAN), a local-area network (LAN), a wireless network, a digital subscriber line (DSL) network, a frame relay network, an asynchronous transfer mode (ATM) network, a virtual private network (VPN), and/or any other suitable communication network. User devices 706 can be connected by one or more communications links (e.g., communications links 712) to communication network 704 that can be linked via one or more communications links (e.g., communications links 714) to server 702. The communications links can be any communications links suitable for communicating data among user devices 706 and server 702 such as network links, dial-up links, wireless links, hard-wired links, any other suitable communications links, or any suitable combination of such links.

User devices 706 can include any one or more user devices suitable for implementing the mechanisms described herein. In some embodiments, user device 706 can include any suitable type of user device, such as mobile phones, tablet computers, wearable computers, laptop computers, desktop computers, smart televisions, media players, game consoles, vehicle information and/or entertainment systems, and/or any other suitable type of user device.

For example, user devices 706 can include any one or more user devices suitable for requesting video content, rendering the requested video content as immersive video content (e.g., as virtual reality content, as three-dimensional content, as 360-degree video content, as 180-degree video content, and/or in any other suitable manner) and/or for performing any other suitable functions. For example, in some embodiments, user devices 706 can include a mobile device, such as a mobile phone, a tablet computer, a wearable computer, a laptop computer, a virtual reality headset, a vehicle (e.g., a car, a boat, an airplane, or any other suitable vehicle) information or entertainment system, and/or any other suitable mobile device and/or any suitable non-mobile device (e.g., a desktop computer, a game console, and/or any other suitable non-mobile device). As another example, in some embodiments, user devices 706 can include a media playback device, such as a television, a projector device, a game console, desktop computer, and/or any other suitable non-mobile device.

In a more particular example where user device 706 is a head mounted display device that is worn by the user, user device 706 can include a head mounted display device that is connected to a portable handheld electronic device. The portable handheld electronic device can be, for example, a controller, a smartphone, a joystick, or another portable handheld electronic device that can be paired with, and communicate with, the head mounted display device for interaction in the immersive environment generated by the head mounted display device and displayed to the user, for example, on a display of the head mounted display device.

It should be noted that the portable handheld electronic device can be operably coupled with, or paired with the head mounted display device via, for example, a wired connection, or a wireless connection such as, for example, a WiFi or Bluetooth connection. This pairing, or operable coupling, of the portable handheld electronic device and the head mounted display device can provide for communication between the portable handheld electronic device and the head mounted display device and the exchange of data between the portable handheld electronic device and the head mounted display device. This can allow, for example, the portable handheld electronic device to function as a controller in communication with the head mounted display device for interacting in the immersive virtual environment generated by the head mounted display device. For example, a manipulation of the portable handheld electronic device, and/or an input received on a touch surface of the portable handheld electronic device, and/or a movement of the portable handheld electronic device, can be translated into a corresponding selection, or movement, or other type of interaction, in the virtual environment generated and displayed by the head mounted display device.

It should also be noted that, in some embodiments, the portable handheld electronic device can include a housing in which internal components of the device are received. A user interface can be provided on the housing, accessible to the user. The user interface can include, for example, a touch sensitive surface configured to receive user touch inputs, touch and drag inputs, and the like. The user interface can also include user manipulation devices, such as, for example, actuation triggers, buttons, knobs, toggle switches, joysticks and the like.

The head mounted display device can include a sensing system including various sensors and a control system including a processor and various control system devices to facilitate operation of the head mounted display device. For example, in some embodiments, the sensing system can include an inertial measurement unit including various different types of sensors, such as, for example, an accelerometer, a gyroscope, a magnetometer, and other such sensors. A position and orientation of the head mounted display device can be detected and tracked based on data provided by the sensors included in the inertial measurement unit. The detected position and orientation of the head mounted display device can allow the system to, in turn, detect and track the user's head gaze direction, and head gaze movement, and other information related to the position and orientation of the head mounted display device.

In some implementations, the head mounted display device can include a gaze tracking device including, for example, one or more sensors to detect and track eye gaze direction and movement. Images captured by the sensor(s) can be processed to detect and track direction and movement of the user's eye gaze. The detected and tracked eye gaze can be processed as a user input to be translated into a corresponding interaction in the immersive virtual experience. A camera can capture still and/or moving images that can be used to help track a physical position of the user and/or other external devices in communication with/operably coupled with the head mounted display device. The captured images can also be displayed to the user on the display in a pass through mode.

Although server 702 is illustrated as one device, the functions performed by server 702 can be performed using any suitable number of devices in some embodiments. For example, in some embodiments, multiple devices can be used to implement the functions performed by server 702.

Although two user devices 708 and 710 are shown in FIG. 7 to avoid overcomplicating the figure, any suitable number of user devices, (including only one user device) and/or any suitable types of user devices, can be used in some embodiments.

In some embodiments, any combination of the subprocesses or processes described herein can be performed by the one or more user devices 706, server 702, or any suitable combination thereof.

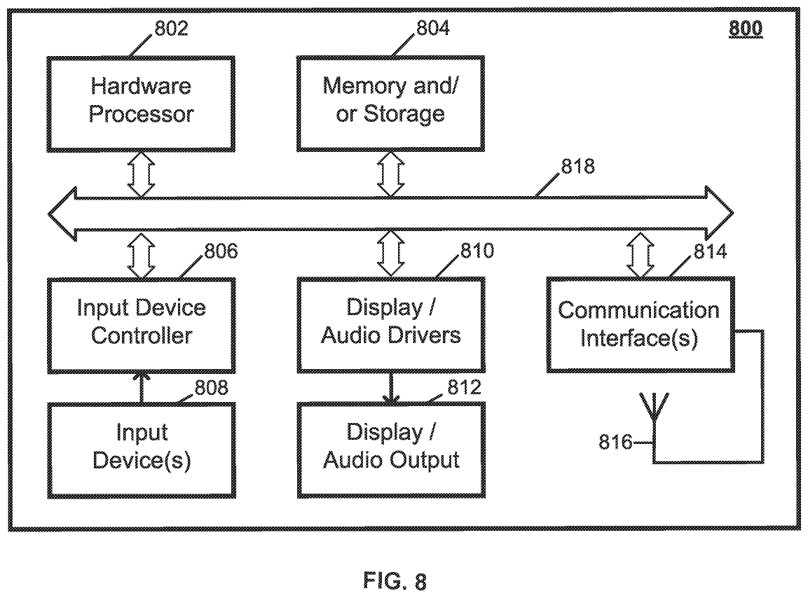

Server 702 and user devices 706 can be implemented using any suitable hardware in some embodiments. For example, in some embodiments, devices 702 and 706 can be implemented using any suitable general-purpose computer or special-purpose computer and can include any suitable hardware. For example, as illustrated in example hardware 800 of FIG. 8, such hardware can include hardware processor 802, memory and/or storage 804, an input device controller 806, an input device 808, display/audio drivers 810, display and audio output circuitry 812, communication interface(s) 814, an antenna 816, and a bus 818.

Hardware processor 802 can include any suitable hardware processor, such as a microprocessor, a micro-controller, a multi-core processor or an array of processors, digital signal processor(s), dedicated logic, and/or any other suitable circuitry for controlling the functioning of a general-purpose computer or a special-purpose computer in some embodiments. In some embodiments, hardware processor 802 can be controlled by a computer program stored in memory and/or storage 804. For example, in some embodiments, the computer program can cause hardware processor 802 to perform functions and methods described herein.

Memory and/or storage 804 can be any suitable memory and/or storage for storing programs, data, documents, and/or any other suitable information in some embodiments. For example, memory and/or storage 804 can include random access memory, read-only memory, flash memory, hard disk storage, optical media, and/or any other suitable memory.

Input device controller 806 can be any suitable circuitry for controlling and receiving input from one or more input devices 808 in some embodiments. For example, input device controller 806 can be circuitry for receiving input from a touchscreen, from a keyboard, from a mouse, from one or more buttons, from a voice recognition circuit, from a microphone, from a camera, from an optical sensor, from an accelerometer, from a temperature sensor, from a near field sensor, and/or any other type of input device.

Display/audio drivers 810 can be any suitable circuitry for controlling and driving output to one or more display/audio output devices 812 in some embodiments. For example, display/audio drivers 810 can be circuitry for driving a touchscreen, a flat-panel display, a cathode ray tube display, a projector, a speaker or speakers, and/or any other suitable display and/or presentation devices.

Communication interface(s) 814 can be any suitable circuitry for interfacing with one or more communication networks, such as network 704 as shown in FIG. 7. For example, interface(s) 814 can include network interface card circuitry, wireless communication circuitry, and/or any other suitable type of communication network circuitry.

Antenna 816 can be any suitable one or more antennas for wirelessly communicating with a communication network (e.g., communication network 704) in some embodiments. In some embodiments, antenna 816 can be omitted.

Bus 818 can be any suitable mechanism for communicating between two or more components 802, 804, 806, 810, and 814 in some embodiments.

Any other suitable components can be included in hardware 800 in accordance with some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory forms of magnetic media (such as hard disks, floppy disks, etc.), non-transitory forms of optical media (such as compact discs, digital video discs, Blu-ray discs, etc.), non-transitory forms of semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that at least some of the above-described subprocesses can be executed or performed in any order or sequence not limited to the order and sequence described herein. Also, at least some of the above subprocesses can be executed or performed substantially simultaneously where appropriate or in parallel to reduce latency and processing times. Additionally or alternatively, at least some of the above described subprocesses can be omitted.

Accordingly, methods, systems, and media for determining viewability of a content item in a virtual environment having particles.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for determining viewability of content items in virtual environments, the method comprising:
selecting a first plurality of pixels of the content item;
determining a first plurality of color values of the first plurality of pixels of the content item;
selecting a second plurality of pixels of an image of a rendered screen of a virtual environment;
determining a second plurality of color values of the second plurality of pixels of the image of the rendered screen of the virtual environment;
comparing the first plurality of color values with the second plurality of color values; and
determining whether the content item being presented within the virtual environment is being obstructed by a visual element based on the comparison.

2. The method of claim 1, wherein the first plurality of color values and the second plurality of color values are red, green, and blue (RGB) color values.

3. The method of claim 1, wherein the first plurality of color values and the second plurality of color values are cyan, yellow, magenta, and black (CMYK) color values.

4. The method of claim 1, wherein selecting the first plurality of pixels of the content item further comprises selecting a first reference pixel of the content item and selecting pixels that are proximate to the reference pixel.

5. The method of claim 4, wherein selecting the first plurality of pixels of the content item further comprises comparing color values of the reference pixel with color values of the pixels that are proximate to the reference pixel.

6. The method of claim 5, wherein selecting the first plurality of pixels of the content item further comprises determining whether to include the first reference pixel in the first plurality of pixels based on the comparison between the color values of the reference pixel with the color values of the pixels that are proximate to the reference pixel.

7. The method of claim 1, wherein the method further comprises selecting a third plurality of pixels of a second image of a second rendered screen of the virtual environment.

8. The method of claim 7, wherein the method further comprises:
determining a third plurality of color values of the third plurality of pixels of the second image of the second rendered screen of the virtual environment;
comparing the first plurality of color values with the third plurality of color values; and
determining that the content item being presented within the virtual environment is being obstructed by the visual element based on the comparison.

9. The method of claim 1, wherein the method further comprises determining that the content item is within a view frustum of the virtual environment before selecting the second plurality of pixels of the image of the rendered screen.

10. The method of claim 1, wherein comparing the first plurality of color values with the second plurality of color values comprises determining that the first plurality of color values and the second plurality of color values are approximately the same.

11. A system for determining viewability of content items in virtual environments, the system comprising:
a hardware processor that is configured to:
select a first plurality of pixels of the content item;
determine a first plurality of color values of the first plurality of pixels of the content item;
select a second plurality of pixels of an image of a rendered screen of a virtual environment;
determine a second plurality of color values of the second plurality of pixels of the image of the rendered screen of the virtual environment;
compare the first plurality of color values with the second plurality of color values; and
determine whether the content item being presented within the virtual environment is being obstructed by a visual element based on the comparison.

12. The system of claim 11, wherein the first plurality of color values and the second plurality of color values are red, green, and blue (RGB) color values.

13. The system of claim 11, wherein the first plurality of color values and the second plurality of color values are cyan, yellow, magenta, and black (CMYK) color values.

14. The system of claim 11, wherein selecting the first plurality of pixels of the content item further comprises selecting a first reference pixel of the content item and selecting pixels that are proximate to the reference pixel.

15. The system of claim 14, wherein selecting the first plurality of pixels of the content item further comprises comparing color values of the reference pixel with color values of the pixels that are proximate to the reference pixel.

16. The system of claim 15, wherein selecting the first plurality of pixels of the content item further comprises determining whether to include the first reference pixel in the first plurality of pixels based on the comparison between the color values of the reference pixel with the color values of the pixels that are proximate to the reference pixel.

17. The system of claim 11, wherein the hardware processor is further configured to select a third plurality of pixels of a second image of a second rendered screen of the virtual environment.

18. The system of claim 17, wherein the hardware processor is further configured to:
determine a third plurality of color values of the third plurality of pixels of the second image of the second rendered screen of the virtual environment;
compare the first plurality of color values with the third plurality of color values; and
determine that the content item being presented within the virtual environment is being obstructed by the visual element based on the comparison.

19. The system of claim 11, wherein the hardware processor is further configured to determine that the content item is within a view frustum of the virtual environment before selecting the second plurality of pixels of the image of the rendered screen.

20. The system of claim 11, wherein comparing the first plurality of color values with the second plurality of color values comprises determining that the first plurality of color values and the second plurality of color values are approximately the same.

21. A computer-readable medium containing computer executable instructions that, when executed by a processor, cause the processor to perform a method for determining viewability of content items in virtual environments, the method comprising:
selecting a first plurality of pixels of the content item;
determining a first plurality of color values of the first plurality of pixels of the content item;
selecting a second plurality of pixels of an image of a rendered screen of a virtual environment;
determining a second plurality of color values of the second plurality of pixels of the image of the rendered screen of the virtual environment;
comparing the first plurality of color values with the second plurality of color values; and
determining whether the content item being presented within the virtual environment is being obstructed by a visual element based on the comparison.
